(19) United States
(12) Patent Application Publication
(10) Pub. No.: US 2013/0198275 A1
(43) Pub. Date: Aug. 1, 2013

(54) AGGREGATION OF MOBILE APPLICATION SERVICES FOR SOCIAL NETWORKING

(71) Applicant: Nils Forsblom, La Quinta, CA (US)

(72) Inventor: Nils Forsblom, La Quinta, CA (US)

(21) Appl. No.: 13/360,557

(22) Filed: Jan. 27, 2012

(51) Int. Cl. G06F 15/16

(52) U.S. Cl. 709/204

(57) ABSTRACT

The aggregation of content elements generated on one or more social networking service sites is disclosed. There is a content request associated with a first user and identifying an independently established account on those sites for various content elements linked thereto. The requested content elements are received, and stored in connection with first aggregation account as social objects additionally defined by a plurality of attributes. A set of data representative of the selection of the social objects and its attributes are generated for rendering on a remote computer system. The selection of the social objects is defined by one or more predetermined conditions.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present disclosure relates generally to online services, and more particularly, to the aggregation of mobile application services for social networking.

2. Related Art

Online, web-based social networking services are popular across a wide demographic of users, and the field in general is experiencing substantial growth. At the most basic level, social networking involves connecting users with each other to communicate and share information. Users typically establish accounts and create profiles containing biographic data such as current location, schools attended, employment experiences, personal relationships, and so forth. Furthermore, various updates of interest with messages, photographs, videos, and links to other sites may be posted on the profile. Access to this personal information may be limited to others that have approved and set up links with the user account. Depending on preference, information of limited privacy concern may be made accessible to secondary contact links, or to all users on the social networking service. A group of contacts, which can mirror the user's real-life personal network, may thus be established online, and a variety of content can be exchanged.

There are a few popular large-scale social networking services that offer many features, customization options, and privacy/sharing settings. Among the most popular for general social networking purposes is Facebook, which currently has over 800 million users worldwide. Also popular, but for the most part limited to business related networking, is LinkedIn, which currently has approximately 135 million users.

Although content sharing functions are available on and are still widely used in such general purpose social networking services, much of the newer development in social networking have narrower function sets. However, substantial development efforts have been focused on usability and accessibility improvements thereto. Service developers have thus endeavored to make those functions available in a mobile environment, typically in the form of applications or “apps” downloadable to the users' mobile devices.

One popular service is Twitter, where various text messages of limited length can be posted by users and viewed by other users who “follow” the author. Further, such content may be re-posted by those users, for further dissemination across the network of “followers.” Unlike other social networking services, it is not necessary for a “follower” to be approved. As such, the messages can effectively be broadcasts to an unlimited audience. The service has incorporated various functions to aggregate and display collections of messages directed to subject matter areas via metadata included directly in the message, so that trends and new topics of interest can be easily visualized. The text messages may be sent from conventional computers with web browser applications, or may be sent from the aforementioned dedicated applications installed on mobile devices.

Another popular mobile social networking service known as Instagram focuses exclusively on sharing pictures, particularly those taken with built-in cameras of mobile phones. Various enhancements can be applied to the recorded pictures, and shared with others or with the public. Since smartphone type devices are ubiquitously carried through daily life, for those inclined to do so, many visual aspect of one's experiences throughout the day can be captured and shared. Aside from Instagram, there are several other popular mobile photo sharing applications such as Picplz also provide the same functionality, but on different mobile platforms.

Mobile devices are commonly integrated with Global Positioning System (GPS) satellite receivers that output geographical location data for sharing and other purposes. To take advantage of such functionality, services such as FourSquare and Gowalla provide “check-in” features where users can announce the various places they have been, whether that be entertainment venues, restaurants, bars, shopping centers, and so forth. Part of the appeal of location-based services is for facilitating real-life interactions with friends that may happen to be in the same area, or to project a certain social network persona as identifying with or frequenting certain types of establishments.

Efforts to combine the various features of messaging, photo sharing, and geolocation have been successful for review sites such as Yelp. After “checking in” to a restaurant, for example, photographs of the interior, as well as the various meals that were enjoyed, can be uploaded to a section dedicated for that restaurant. This can be followed up with contributing a simple star-based rating, or by posting a detailed review. Thereafter, other users who may be in the vicinity and have not yet made meal plans can search for nearby restaurants based on the geolocation data provided by the mobile device, view the posted photographs and read the previous patrons' reviews to determine whether that restaurant is a suitable choice.

One of the limitations associated with existing state of that art is that the aforementioned social networking services such as Twitter, Instagram, FourSquare, and the like are restricted to independent data silos. In other words, data sharing between the social networking services is limited, and establishing a network of contacts requires users to do so in the context of those individual services. The privacy settings, defaults, and policies may differ substantially from one service to another, which can make data sharing a challenge. Some efforts have been made to combine the user-generated content, but these have so far been limited to “dashboard” type applications that simply pull the data from each service to display to the user. In some cases, application programming interfaces (APIs) can be used to cross-post content originating from one service and displaying the same within the same structure and framework of a host service. For example, an Instagram photo can be shown as a Facebook post in a manner similar to other content originating on Facebook, except with an indicator that the source is Instagram.

Furthermore, on a more fundamental level, existing social networking services generally rely upon a “news ticker” framework, where user generated content is shared with others on a time-sequenced basis. For instance, content generated by a user at an earlier time is placed in a less accessible position than content generated by another user at a later time. Again, some social networking services have developed decision-making engines that would place certain content above others depending on the relationship between the viewing user and the generating user, similarities to previous content that was indicated as important by the viewing user, and so forth. However, the content display modality remains based on the aforementioned time-sequenced “ticker” framework, and thus largely retains the deficiencies associated therewith. Accordingly, there is a need in the art for the aggregation of mobile application services for location-based social networking.

### BRIEF SUMMARY

In accordance with various embodiments of the present disclosure, a single cross-platform site to unify various social networking services is contemplated. The users' locations, pictures, and other types of life experiences are collected and processed as moments for subsequent use. These moments can grow and adapt to new contexts, and presents a way to visualize, discover, and socialize with other users, groups or communities that revolve around that particular user, or any other location worldwide in real time.

One aspect involves a method for the aggregation of content elements generated on one or more social networking service sites by a first user. The method may include transmitting a first content request from an aggregation platform system to preselected ones of the one or more social networking service sites. The content request may be associated with the first user and identify an independently established account of the first user and content elements linked thereto on the preselected ones of the one or more social networking service sites. There may also be a step of receiving selected ones of the content elements generated by the social networking service sites. The content elements may be generated in response to the first content request. Furthermore, there may be a step of storing the received content elements as social objects in connection with a first aggregation account for the first user on the aggregation platform system. The social objects may each be defined by a plurality of attributes. The method may also include generating on the aggregation platform system a set of data representative of the selection of at least one of the social objects including one or more of the attributes thereof for rendering on a remote computer system. The selection of the social objects may be defined by one or more predetermined conditions.

Another aspect of the disclosure contemplates a method for aggregating social objects on a unified platform. The method may include presenting login credentials for a first aggregation account from a client system to the unified platform. There may also be a step of transmitting, upon a login approval, social object requests to the unified platform for selective retrieval of the social objects specified thereby. The content elements received from one or more social networking service sites may be stored on the unified platform as the social objects, along with associated attributes. There may be a step of receiving a set of data representative of selected ones of the social objects on the client system. A first one of the attributes associated with the social objects may be at least partially determinative of which of the social objects are selected. The method may further include rendering the set of data representative of the selected ones of the social objects on the client system in an arrangement at least partially determined by a second one of the attributes associated with the social objects.

The present disclosure will be best understood by reference to the following detailed description when read in conjunction with the accompanying drawings.

### BRIEF DESCRIPTION OF THE DRAWINGS

These and other features and advantages of the various embodiments disclosed herein will be better understood with respect to the following description and drawings, in which:

FIG. 1 is a block diagram illustrating one exemplary environment in which various embodiments of the present disclosure may be implemented, including client computer systems, a social network aggregation platform system, and a various external third party social networking services;

FIG. 2 is a flowchart illustrating a method for aggregation of content in accordance with one embodiment of the present disclosure;

FIG. 3 is a data structure diagram of a social object;

FIG. 4 is a flowchart illustrating a method for aggregating social objects on a unified platform in accordance with another embodiment of the present disclosure;

FIG. 5 is an example interface to the network aggregation platform rendered on a user computer system upon initial login;

FIG. 6 is a screen shot illustrating a personal social object tracking feature of the interface to the social network aggregation platform;

FIG. 7 is a screen shot illustrating an incoming social object tracking feature of the interface to the social network aggregation platform;

FIG. 8 is a screen shot illustrating a selected social object tracking feature of the interface to the social network aggregation platform; and

FIG. 9 illustrates a social discovery feature of the interface to the network aggregation platform.

Common reference numerals are used throughout the drawings and the detailed description to indicate the same elements.

### DETAILED DESCRIPTION

A social networking aggregation platform and methods for aggregating content from different social networking services is disclosed. The platform may be accessed seamlessly across various client devices to browse user-generated content from disparate social networking services as social objects in a unified and augmented real-world experience. The detailed description set forth below in connection with the appended drawings is intended as a description of the several presently contemplated embodiments of these systems, platforms, and methods, and is not intended to represent the only form in which the disclosed invention may be developed or utilized. The description sets forth the functions and features in connection with the illustrated embodiments. It is to be understood, however, that the same or equivalent functions may be accomplished by different embodiments that are also intended to be encompassed within the scope of the present disclosure. It is further understood that the use of relational terms such as first and second and the like are used solely to distinguish one from another entity without necessarily requiring or implying any actual such relationship or order between such entities.

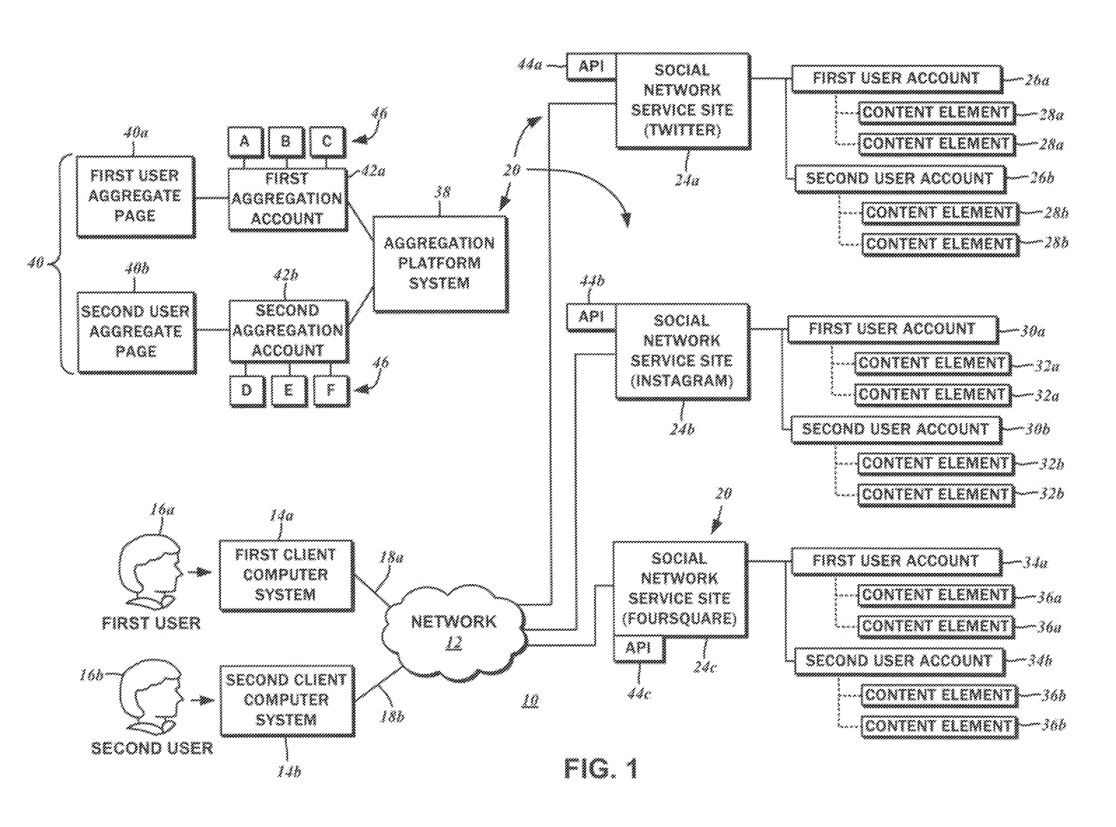

The block diagram of FIG. 1 illustrates an exemplary networked computing environment 10 within which various embodiments of the present disclosure may be implemented. Generally, there are understood to be a variety of computer systems that are interconnected via a network 12 such as the publicly accessible Internet. While the network 12 is referred to in the broadest sense as encompassing any link over which data communications may be proceed between network nodes, presently, the Internet 12 solely has the existing infrastructure of independently operated servers for implementing the functionality of the various social networking services accessed in accordance with the present disclosure.

Connected to the network 12 are a first client computer system 14a and a second client computer system 14b, operated by a first user 16a and a second user 16b, respectively. The client computer systems 14 may be a conventional personal computer device including a central processing unit, memory, and various input and output devices such as keyboards, mice, and display units. The client computer systems 14 are each connectable to the network 12 via a network link 18a, 18b respectively. Alternatively, however, the client computer system 14 may be a mobile device such as a smart phone, a tablet computing device, a notebook computer, or any other suitable portable data processing apparatus that may be implemented functionality contemplated in the present disclosure as described more fully below.

The client computer systems 14 may each have executable instructions of a web browser application that are loaded thereon. The web browser application communicates with various servers 20 also connected to the network 12 over the hypertext transfer protocol (HTTP), among other protocols known in the art. Requests for data are initiated by the client computer systems 14 and transmitted to the servers 20, which in turn transmit the requested data back to the client computer systems 14. In certain embodiments where the client computer system 14 is a mobile device capable of executing standalone applications, there may not be a need for a specific web browser application. Further, in a conventional desktop computing environment it is also possible to utilize dedicated applications to access the network 12 and the servers 20 connected thereto. It is understood, however, that such applications also communicate with the servers 20 over the same protocols (namely, HTTP), though rendering the requested content may not be identical to the way the web browser application renders it. Whether relying upon a conventional general-purpose web browser application or a dedicated mobile device application, the client computer system 14 performs various steps that embody the methods of the present disclosure, the details of which will be described more fully below.

In accordance with various embodiments, the servers 20 may be World Wide Web (Web) servers that process requests from the client web browser applications and deliver requested Hypertext Markup Language (HTML) pages as briefly described above. The servers 20 may be computer systems with processors, memory, data storage devices, and network interface devices that run are managed by an operating system and run web application servers. It will be recognized that in addition to serving static hypertext documents, interactive web-based applications can be implemented on the servers 20.

One such application is a social networking service, and in the exemplary networked computing environment 10, there is a first social networking service site 24a, a second social networking service site 24b, and a third social networking service site 24c. By way of example only and not of limitation, the first social networking service site 24a may be Twitter, the second social networking service site 24b may be Instagram, and the third social networking service site 24c may be FourSquare. These examples have been chosen only for the purpose of ready identification of particular social networking service sites 24, the user accounts thereon, and the content elements associated with those user accounts. For instance, a user account associated with the first social networking service site 24a may also be referred to as a Twitter account, and the content linked thereto being referred to as a Twitter content element. It will be appreciated by those having ordinary skill in the art that such reference to specific social networking service sites is not intended to be limiting; any other social networking service site may be substituted, and additional social networking service sites may also be utilized besides the three mentioned herein. According to one embodiment of the present disclosure, each of the foregoing social networking service sites 24 have both a web-based component as well as a mobile application component. That is, the social networking service sites 24 may be accessed via a conventional web browser application, or alternatively, via a dedicated mobile application.

Continuing with the example above involving the first user 16a and the second user 16b, on each of the social networking service sites 24a-24c, such users 16 have established user accounts. On the first social networking service site/Twitter site 24a, the first user 16a has a first Twitter account 26a and the second user 16b has a second Twitter account 26b. The first Twitter account 26a may be linked to one or more corresponding Twitter content elements 28a, while the second Twitter account 26b may be linked to one or more Twitter content elements 28b. Particular to the Twitter site 24a, the Twitter content elements 28 may be text messages originating from the users 16 themselves, or others they may have reposted. In some cases it is also possible to include geographic (GPS) coordinates of the location from which the text message was originated, so that information may also be included in the Twitter content elements 28.

Along these lines, on the second social networking service site/Instagram site 24b, the first user 16a similarly has a first Instagram account 30a and the second user 16b has a second Instagram account 30b. Linked to the first Instagram account 30a are one or more Instagram content elements 32a that are uploaded or otherwise associated with the first user 16a. Linked to the second Instagram account 30b are one or more Instagram content elements 32b from the second user 16b. As mentioned above, Instagram is a photo sharing site, so the Instagram content elements 32 are understood to be photographs captured by the users 16, typically via integrated cameras of mobile devices. A short description or caption may accompany the photographs, as well as GPS coordinates of the location in which the photograph was taken, so such data may also be incorporated into the Instagram content elements 32.

With regard to the third social networking service site/FourSquare site 24c, the users 16 are understood to have FourSquare accounts 34, with the first user 16a being associated with a first FourSquare account 34a and the second user 16b being associated with a second FourSquare account 34b. The FourSquare site 24c is understood to be a geo-tagging site that accepts “check-ins” comprised of GPS coordinate data from its users 16 via their mobile devices, and so such data is included in the FourSquare content elements 38.

It is to be understood that while specific content elements of the various social networking service sites 24 have been described, these are not intended to be limiting, and other types of information may be received and stored thereby. For example, video can be shared via the SocialCam service and related mobile application, recorded sound data can be shared via the SoundCloud service and related mobile application, and product/service reviews can be shared via the Yelp, Stamped or other review-based social network service sites and related mobile applications. There are many other social networking service sites that are centered on other types of content such as recommendations, and the specific items of content contributed by the users are referred to generally herein as content elements.

In the illustrated example, two user accounts are shown for each of the social networking service sites 24, with each user account being linked to two content elements. It will be appreciated that an arbitrary number of accounts may be established on the social networking service sites 24, and need not be limited to the example first user 16a and second user 16b. In some circumstances, a given user 16 may not have accounts on certain ones of the social networking service sites 24, with little to no change in the functionalities disclosed herein. Along these lines, more or less than the illustrated two content elements may be linked to each of the user accounts of the social networking service sites 24.

In accordance with various embodiments of the present disclosure, there is an aggregation platform system 38 that retrieves the disparate content elements from the various social networking service sites 24 and presents the same to the users 16 in a unified manner. In one exemplary embodiment, this unified view is presented as an aggregation page 40 specific to the user 16 to which it is generated and transmitted. The first user 16a is presented with a first user aggregation page 40a, while the second user 16b is presented with a second user aggregation page 40b. One implementation involves aggregation accounts 42 established on the aggregation platform system 38, with various preferences and the selection of content elements of the aggregation page 40 being stored therein. It is expressly contemplated that the users 16 are able to interact with and manage the display of the content elements independently of the social networking service sites 24 without logging on to each. The aggregation platform system 38, like the social networking service sites 24, is understood to be a Web server that is capable of receiving requests from the client computer systems 14 and responding to those requests.

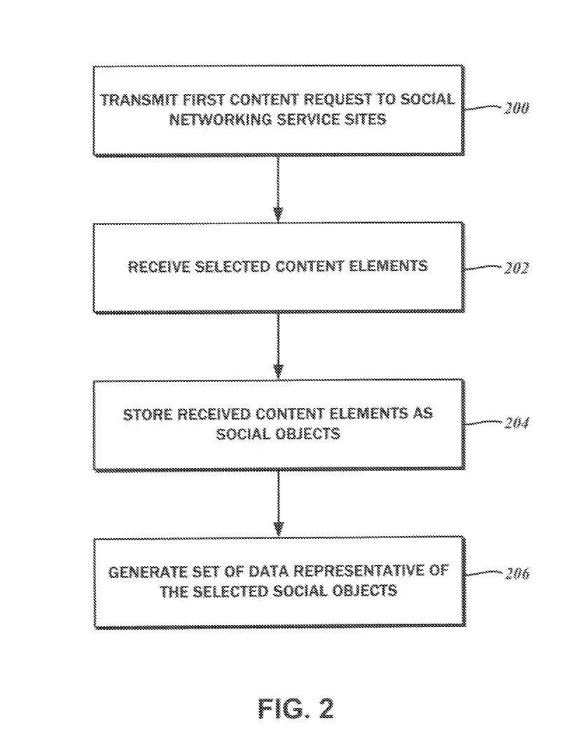

With reference to the flowchart of FIG. 2, a method for aggregating content elements generated on the one or more social networking service sites 24 is contemplated in accordance with various embodiments of the present disclosure. The method may begin with a step 200 of transmitting a first content request to preselected ones of the one or more social networking service sites 24. This first content request may originate from the aggregation platform system 38, and may further be associated with the first user 16a. Where the preferences set in the first user aggregation account 42a establishes links to the first Twitter account 26a, the first content request includes instructions to retrieve one or more of the first Twitter content elements 28a. The preferences in the first user aggregation account 42a may further establish links to the first Instagram account 30a and the first FourSquare account 34a, in which the first content request includes instructions to retrieve one or more of the first Instagram content elements 32a, and one or more of the first FourSquare content elements 36a. To the extent that the first user 16a does not establish a link between the first user aggregation account 42a and any one of the user accounts on the social networking service sites 24, the content elements of the unlinked social networking service sites 24 are not part of the first content request, regardless of whether or not the first user 16a has an account established with that social networking service site 24.

The aggregation platform system 38 may transmit the first content request to the social networking service sites 24 through its respective application programming interfaces (APIs) 44. It is understood that the API 44 serves as an open interface between two independent components such as the social networking service sites 24 and the aggregation platform system 38. Using the API 44, the underlying content element data stored on the social networking service sites 24 may be directly accessed by the aggregation platform system 38. With most existing social networking service sites 24, the aggregation platform system 38 may periodically initiate the first content requests in a polling fashion. This type of arrangement does not require that the social networking service sites 24 be aware of or tie back to the aggregation platform system 38. In some embodiments, such polling system need not be necessary because of a bi-directional/return relationship back to the aggregation platform system 38 from the social networking service site 24 is established. Whenever new content is posted, the social networking service site 24 can initiate the transmission of the content elements in a “push” type architecture. For these embodiments, the transmitting of the first content request may be eliminated, with independent processes being initiated from the social networking service sites 24 in response to the posting of new content.

The method continues with a step 202 of receiving selected ones of the content elements generated by the social networking service sites 24 in response to the first content request. As indicated above, the aggregation platform system 38 is in communication with the social networking service sites 24 through the respective APIs 44, and the social networking service sites 24 are understood to respond with whichever content elements that were requested. The first content request may specify that all content elements associated with the first user 16a be returned, or that certain new content elements posted after the latest transmission to the aggregation platform system 38 be returned. Various other filtering conditions may be applied. Thus, in certain embodiments, it is the aggregation platform system 38 that governs and selects which content elements are received. The content elements may represent any type of data that is shared within the social networking service site, and such data and may be passed to the aggregation platform system 38 in accordance with any data interchange standard. One common standard in the Web arena is JavaScript Object Notation (JSON).

Upon receipt of the content elements from the social networking service sites 24, those content elements are stored as social objects 46. From the received data that is structured according to the aforementioned interchange format, individual elements may be parsed and stored in social objects 46 in a step 204. The received content elements that are to be associated with the first aggregation account 42 originate from the user accounts of the first user 16a on the social networking service sites 24, i.e., the first Twitter account 26a, the first Instagram account 30a, and the first FourSquare account 34a.

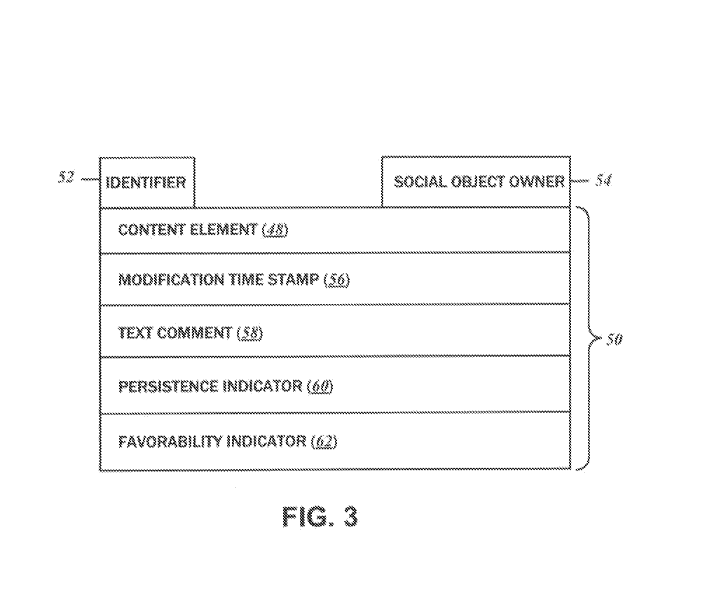

With reference to the block diagram of FIG. 3, one example data structure of the social object 46 is comprised of the content element 48, along with a plurality of attributes 50. Depending upon the specific implementation of the aggregation platform system 38, the social object 46 may also include a unique identifier 52, by which the social object 46 is linked to from a particular aggregation account 42. Alternatively, the social object 46 may include an object owner identifier 54 that associated the same with a particular aggregation account 42. The link between the aggregation account 42 and the social object 46 may be bidirectional, where both the identifier 52 and the owner identifier 54 are utilized. The uses of the specific attributes 50 will be described in further detail below, but as a general overview these include a modification timestamp 56, a text comment 58, a persistent indicator 60, and a favorability indicator 62. Where the content element itself includes multiple data elements such as a combination of text and location information as with the Twitter content element 28, or a combination of an image an location information as with the Instagram content element 32, then those are intended to be encapsulated within the content element 48 of the data structure, though embodiments where such additional data are parsed into other attributes of the social object 46 are also contemplated.

The method continues with a step 206 of generating a set of data representative of the selection of the social objects 46, including the attributes thereof. In one embodiment, this set of data is the aforementioned aggregation page 40, which is contemplated to be rendered on the first client computer system 14a. As indicated above, the selection of the social objects 46 depends upon one or more predetermined conditions. In order for the set of data to be rendered on the first client computer system 14a, the method may also include transmitting the same thereto.

Additionally, at least a subset of the data representative of the selection of at least one of the social objects including one or more the attributes thereof may be transmitted to the second client computer system 14b for viewing by the second user 16b by way of the second user aggregation account 42b. The social objects associated with the first user aggregation account 42a may be transmitted to the second client computer system 14b where the second user aggregation account 42b has established some linked relationship to the first user aggregation account 42a. Further, the aforementioned condition for selecting which of the social objects 46 are selected may depend upon the existence of such linked relationship.

One embodiment of the present disclosure contemplates “follower” type relationships, where one user “follows” or otherwise subscribes to the content generated by another user. Establishing this relationship does not require the approval of the user to whom it is requested. However, it need not be limited thereto, and other linked relationships that require approval such as a bi-directional “friend” type relationship may also be substituted. For purposes of further organizing the relationships with other users on the aggregation platform system 38, it is also possible to define groups and specify users with memberships in those groups.

Some of the content elements belonging to the second user 16b may similarly be shared with the first user 16a through the aggregation platform system 38. At an earlier time, the aggregation platform system 38 may transmit a second content request to another preselected ones of the one or more social networking service sites 24. The second content request involves the second user 16b, and so the content elements associated with each of the second user accounts, i.e., the second Twitter account 26b, the second Instagram account 30b, and the second FourSquare account 34b are requested. These second user accounts are understood to be independently established by the second user 16b. Such content elements are retrieved, and stored as the social objects 46 in connection with the second user aggregation account 42b.

Aside from sharing social objects 46 between users that have an established follower relationship, it is also contemplated that even without such relationship, the social objects 46 may be shared if the first user 16a and the second user 16b are located within a predefined distance of each other. Thus, the predefined condition for selecting which of the social objects 46 are selected for sharing may depend on a location comparison. The setting of the threshold distance may depend upon user input to a locally rendered interface to the aggregation platform system 38. The details of the interface, together with the setting of the proximity threshold therein, will be explained more fully below.

The order or arrangement of rendering the social objects 46 on the client computer system 14, whether it be the first user's 16a own social objects 46 associated with the first user aggregation account 42a individually, or in combination with the second user's 16b shared social objects 46, may be based upon a variety of different procedures. As mentioned above, the social objects 46 can accept modifications to the text comment 58, the persistence indicator 60, and the favorability indicator 62. Whenever such modifications occur, the modification timestamp 56 may be updated. In its simplest form, the order may be set by the modification time stamp 56. For example, when a comment text has been added to the second social object 46b but the first social object 46a has no modifications, then the second social object 46b may be visually arranged first.

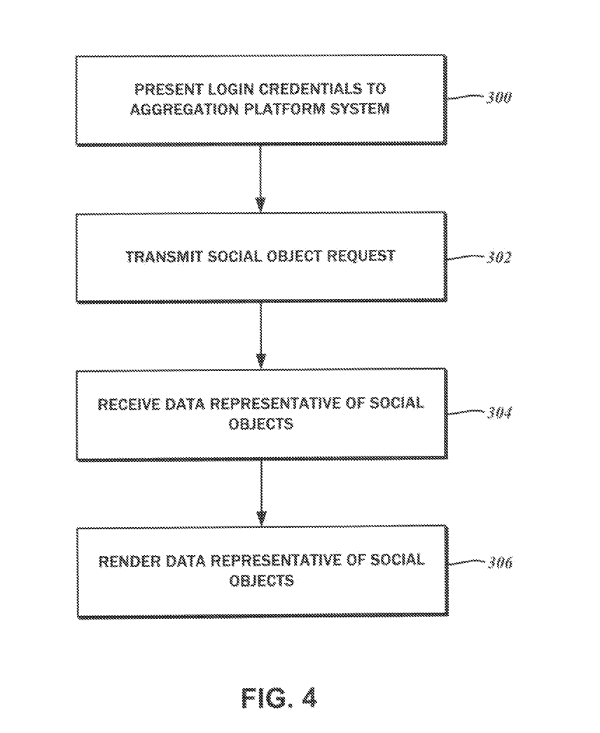

Referring now to the flowchart of FIG. 4, another embodiment of the present disclosure contemplates a method for aggregating the social objects 46 with the unified aggregation platform system 38. Whereas the method described previously in connection with FIG. 2 related to features from the perspective of the aggregation platform system 38, this method is directed to features from the perspective of the client computer systems 14. The method may be implemented with a series of instructions embodied as HTML5 code and other scripting languages, executed by the client computer systems 14. In this regard, there is contemplated an article of manufacture comprising a non-transitory program storage medium that is readable by such computer systems. The program storage medium has stored thereon the series of instructions that implement the method for aggregating the social objects 46. The steps of the method will be described from the perspective of the first user 16a and the first client computer system 14a used thereby. It will be appreciated, however, that these steps are also applicable to any other user of the aggregation platform system 38, such as the second user 16b utilizing the second client computer system 14b. Any specific reference to the first client computer system 14a and the first user 16a are for illustrative purposes only and not of limitation.

The method begins with a step 300 of presenting login credentials to the aggregation platform system 38 for the first user aggregation account 42a. An initial login screen may be transmitted to the first client computer system 14a, with such login screen including an input form for providing a user or account name and a password. These login credentials are then validated by the aggregation platform system 38. If access is granted, the first client computer system 14a may be redirected to the first user aggregation page 40a, which is understood to correspond to the aforementioned set of data representative of the selection of at least one of the social objects 46. While the first user aggregation page 40a is being rendered by the browser application running on the first client computer system 14a, a script included therein may initiate a transmission of social object requests to the aggregation platform system 38 according to step 302 of the method. The social object request is referenced in its broadest sense, and may encompass the initial request from the first client computer system 14a to retrieve the first user aggregation page 40a that may be automatically initiated as a result of the redirect following the login procedure.

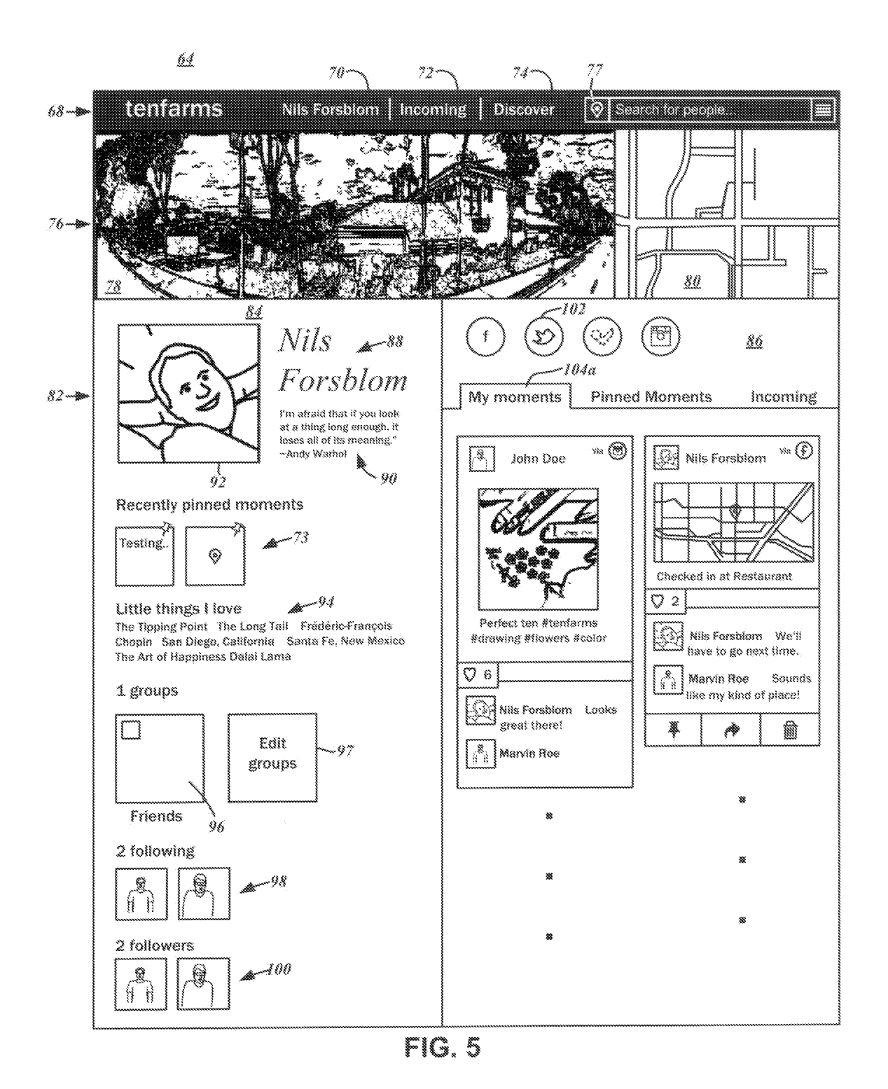

The screenshot of FIG. 5 illustrates one exemplary embodiment of a user interface 64 to the aggregation platform system 38 that may be embodied in the first user aggregation page 40a. By way of example only and not of limitation, it may be segregated into several different sections each displaying different information and including interactive elements for navigating the functions of the aggregation platform system 38. Upon initial login, the user interface 64 defaults to displaying information pertaining to the first user 16a. Along a top portion 68, there is a user home icon/button 70 that upon selection, regenerates the user interface 64 according to the default layout and displaying the default information. Furthermore, there is an incoming button 72 and a discover button 74, both of which are considered to be frequently accessed functions, hence its preferred position and top portion 68 of the user interface 64. The details of the function invoked by the incoming button 72 and the discover button 74 will be more fully described below.

Immediately below the top portion 68 is a map portion 76, which is divided into a street view 78 and a map view 80. As indicated above, some of the social objects 46 may be further defined by location attributes. In the map portion 76, the location attribute of the most recently updated social object 46 is used to retrieve a street-level view of the location, along with the map view of the same. By activating a location selection button 77, a listing of recent moments and associated location information is displayed. Thereafter selecting one of the moments sets the street view 78 and the map view 80 to the specified location. The data for the image representing the street-level view and the data for the image represent the map view may be retrieved from any web-based mapping application such as Google Maps, Bing Maps, or the like.

A body portion 82 includes a profile section 84 and a social objects navigation section 86. The profile section 84 can display a name 88, a brief autobiographical statement 90, and a picture 92 of the first user 16a. Furthermore, the profile section 84 can display a set of interests of the first user 16a. In various parts of the user interface 64, the profile pictures of various users 16 are displayed. Selecting the profile pictures may be operative to generate that user's respective profile having an appearance and layout much like the profile section 84 of the first user 16a.

As mentioned above, the users 16 can be segregated into different groups, and a groups section 94 implements various ways to visualize and modify membership. A group container 96 is labeled with a group name, and shows the profile picture 92 of the users 16 that are part of that group. A group editing box 97 is understood to be an activatable user interface element that invokes a secondary screen for adding new groups and removing existing groups, adding and removing users 16 to and from groups, and modifying the name of the group.

Furthermore, it was noted that the various aggregation accounts 42 may be linked to each other in a “follower” relationship, either as being followed by or following one or more of the other users 16. The users 16 whom the first user 16a is following are displayed in a “following” section 98 and the users 16 following the first user 16a are displayed in a “follower” section 100.

The first user aggregation account 42a is linked to one or more social objects 46, with the content element 48 thereof being retrieved from one of the social networking service sites 24. The method continues with a step 304 of receiving the set of data representative of selected ones of the social objects 46, which in one embodiment may be part of the first user aggregation page 40a. The specific ones of the social objects 46 to transmit from the aggregation platform system 38, and in turn received by the client computer system 14, are determined at least partially by the attributes 50 of the social object 46.

Within the social object navigation section 86 are a series of icons 102 representative of the various social networking service sites 24 from which the social objects 46 are being retrieved. Where a link to the specific user accounts on the social networking service sites 24 have been established, the icons are shown with full contrast, indicating that such link is active. However, where no links have been made, or if the user 16 does not have corresponding independent accounts on any of the social networking service sites 24, then the icons representative thereof are shown subdued. These icons are also active and can be selected to invoke a separate window in which the login credentials may be supplied to establish the link, or alternatively to register for a new account.

As a general matter, the user interface 64 treats and renders each of the social objects 46 as life moments. The social object navigation section 86 is segregated into three separate panels to render three different categories of moments, as further defined by the attributes 50 of the corresponding social objects 46. It is understood that only those that are to be displayed within the user interface 64 are requested in step 302, and subsequently received in step 304; thus the earlier stated aspect of the first one of the attributes 50 being at least partially determinative of which ones are selected for passing to the user interface 64. The method continues with a step 308 of rendering the set of data representative of the selected ones of the social objects 46. The rendering arrangement or order is at least partially determined by a second one of the attributes 50.

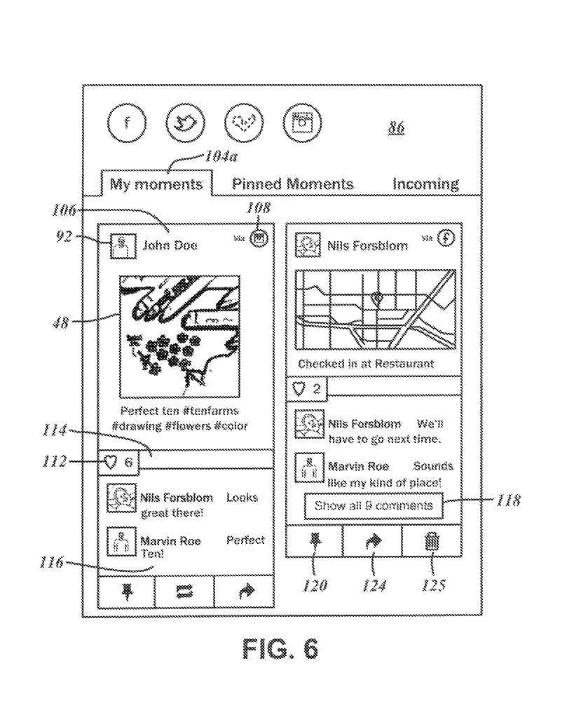

FIG. 6 illustrates a personal social object tracking feature under a “My moments” panel 104a. The moments included here are understood to be those social objects with which the first user 16a has interacted in any fashion via the aggregation platform system 38, including those of the associated with the first user aggregation account 42a or any other aggregation account 42, for that matter. Possible interactions include adding the text comment 58 or the favorability indicator 62, amongst several others appropriate for different types of social objects 46. The content element 48, which for exemplary purposes is a photograph, is rendered within a bounding box 106 together with text comments that are a part of the content element 48. A miniaturized version of the profile picture 92 and the name of originator of the social object 46 as deduced from the owner identifier 54 are also shown, as well as an icon 108 identifying the source social networking service site 24, which in this case is Instagram. An age indicator 110 shows how long ago temporally the social object 46 was posted to the social networking service site 24.

A favorability icon 112 serves as a count of how many other users 16 have set the favorability indicator 62 for that particular social object 46, as well as an active user interface element to increment the favorability indicator 62. It is understood that the users 16 select the favorability icon 112 whenever the content element 48 to which it applies is enjoyed, appreciated, or otherwise “liked.”

Text comments 58 can be added via a text input box 114 with all comments being so added displayed in reverse chronological sequence in a variable size comment box 116. The text of each comment is accompanied by its author and a miniaturized profile picture 92 thereof. When the number of text comments 58 exceeds a certain threshold, some may be removed from view, and substituted with an expansion button 118, the activation of which regenerates the view with all of the text comments 58.

Where the moment is that associated with the first user 16, other actions may be taken in relation thereto. For instance, it is possible to pin or make persistence via a pin button 120, or forward to another aggregation account 42 via a forward button 124. Alternatively, the moment may be removed via a trash button 125.

The order in which the moments are rendered within the panel 104a is established by the modification timestamp 56. In accordance with one embodiment, the social objects 46 are shown in reverse chronological order from left to right and top to bottom. As indicated above, whenever the social object 46 or its attributes 50 are modified in some way, the modification timestamp 56 is updated. It is therefore contemplated that whenever there is any activity with respect to any social object 46, it remains contextually and visually relevant by being positioned accordingly—at the top of the panel 104a. It is expressly contemplated that other, more sophisticated modalities of setting the order of the displayed moments is possible utilizing other attributes 50, analyzing historical usage patterns of the first user 16a and any other that may be related, and so forth. Those heaving ordinary skill in the art will be able to ascertain any such variations.

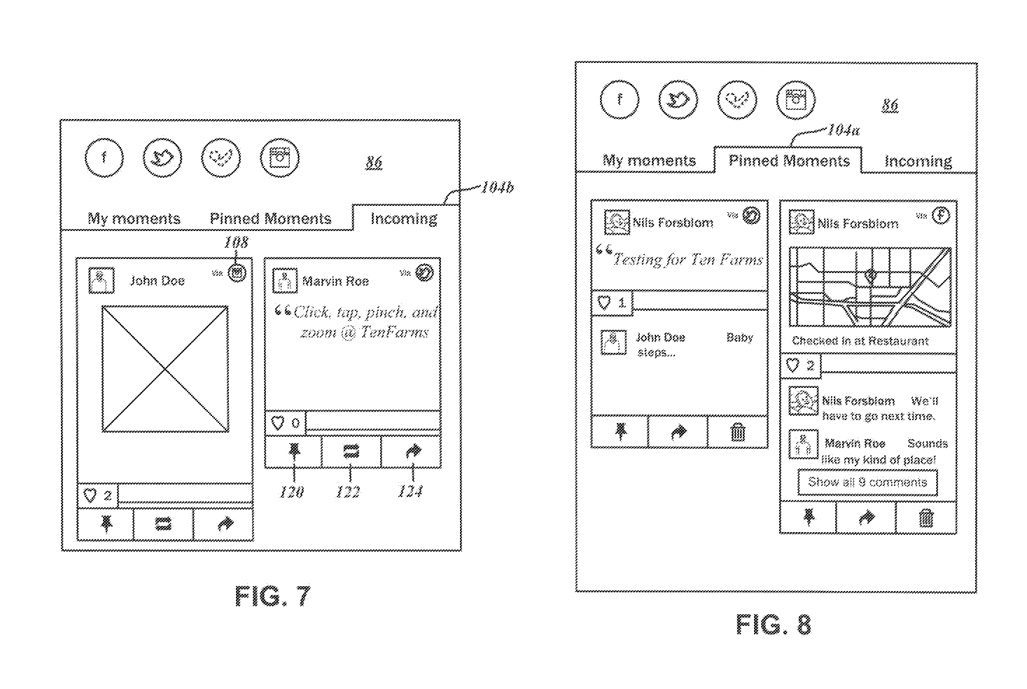

With reference to the screen shot of FIG. 7, an incoming social object 46 tracking feature is contemplated under an “Incoming” moments panel 104b. It was discussed previously that the first user aggregation account 42a may be linked to others such as the second user aggregation account 42b in a follower/following relationship. “Incoming” moments are understood to be those that originate from the other users that have such a linked relationship. These types of moments may be pinned or made persistent via the pin button 120, re-shared via a share button 122, or forwarded to a specific user or multiple users via the forward button 124. One contemplated modality by which the existence of the follower/following relationship can be determined is by a comparison of the owner identifier 54 of the social object 46, against each of the aggregation account 42 that are linked to the first user aggregation account 42a, though any other suitable one validly may be substituted without departing from the scope of the present disclosure. The order of rendering the moments is the same as above with the use of the modification timestamp 56. The functionality and view of the moments invoked through the incoming moments panel 104b is similar to the function that is invoked through the incoming button 72 on the top portion 68 of the user interface 64. Instead of being limited to display within the social object navigation section 86, activating the incoming button 72 renders the display of moments using more of the available interface real estate.

When moments are pinned, that is, when the persistence indicator 60 that is one of the attributes 50 of the social object 46 is set, a selected or persistent social object tracking feature may be invoked. As shown in FIG. 8, such persistent social objects 46 may be displayed under a “Pinned” moments panel 104c. It is possible to pin or make persistent a social object 45 that is associated with the first user aggregation account 42a, or any other aggregation accounts 42. The pinned moments may serve as a collection of various content elements that were or are of interest to the first user 16a, and the short, medium, or long term pattern intelligence therein may be further leveraged for processing content elements encountered in the future. A collection 73 of recently pinned moments may also be displayed in the profile section 84.

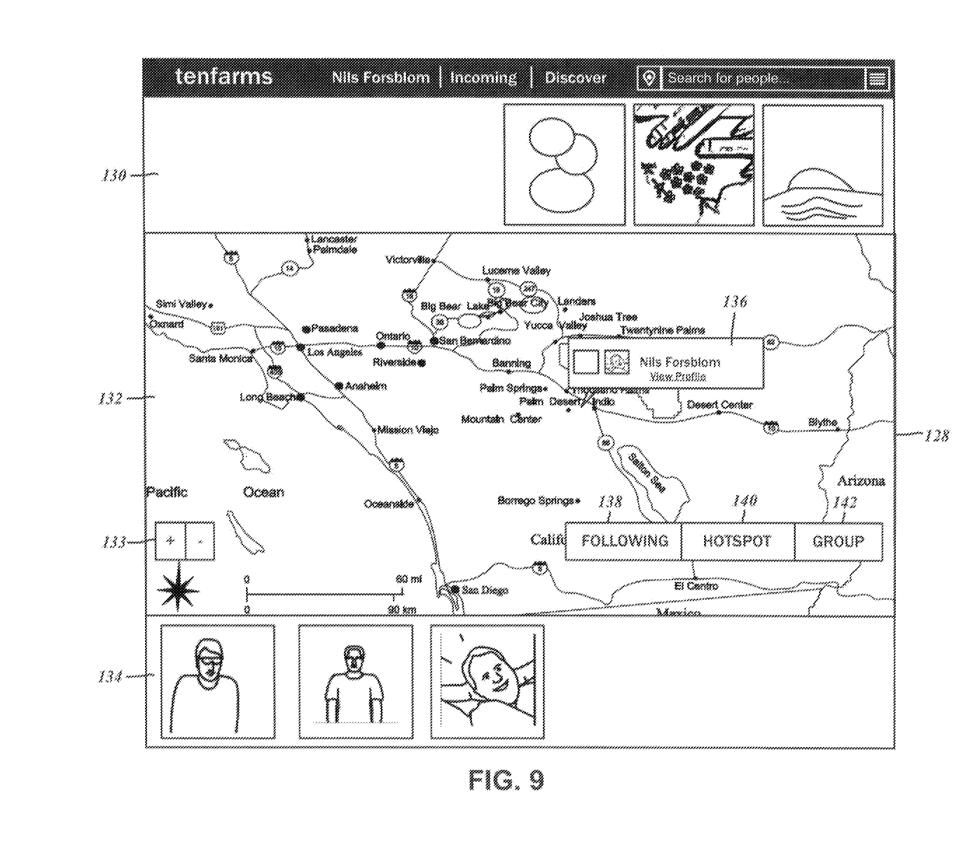

Rather than being limited to other users 16 with whom the first user 16a has existing relationships for featuring content elements, the present disclosure further contemplates another modality by which social networking “moments” of other users may be discovered. With reference to the screenshot of FIG. 9, activating a discover button 126 clears the user interface 64 and generates a new discovery interface 128. However, the top portion 68 remains as before. By way of example only and not of limitation, the discovery interface 128 is segregated into a moments section 130, a map section 132, and a local users catalog section 134.

It is contemplated that the functionality of the discovery interface 128 is largely driven by the particular view and location shown in the map section 132. Specifically, the geographical area shown on the map defines the bounds of the location-enhanced moments that may be displayed therein. Per conventional implementations of web-based mapping interfaces, the map view may be panned by dragging the map interface, and the map view may be zoomed in and zoomed out using magnification buttons 133.

Using the collection of all of the moments captured on the aggregation platform system 38, those moments having location values that are within the geographic bounds are overlaid as markers 136 on the map. Each moment is represented by the corresponding picture to the extent its content element 48 includes one. Generic icons for those moments not linked to any icons are also possible. Upon selecting one of the markers 136 through the interface, it may be expanded to include the profile picture 92 and name of the owner of the moment, together with a link to the expanded profile mentioned above.

It is understood that each moment is associated with at least one user 16. Accordingly, a visual inventory that shows the profile pictures 92 of all of the users having stored moments within the location displayed on the map may be generated on the local users catalog section 134. The other users 16 that are presented to the first user 16a need not be followers, or be users that follow the first user 16a. Based on location and similar interests, it is envisioned that new connections to other users may be established by interacting with that user's moment, whether that be “liking” it, adding text comments to it, or pinning it.

With a large number of moments and users, there is a potential for clutter on the map view, and so the map section 132 provides persistent buttons for different filter conditions. There is a following filter button 138, which limits the display to moments belonging to users 16 with whom the first user 16a has a following/followed relationship. Furthermore, there is a hotspot filter button 140, which changes the focus of the map to those locations with the most recent, most numerous activity. Limiting the view to those moments owned by certain groups that the first user 16a has established is also possible through a group button 142. In addition to the foregoing user-based manipulation of the map view to avoid visual clutter, the automatic grouping of proximal markers into aggregate markers is also contemplated. One possible modality is disclosed in U.S. patent application Ser. No. 13/211,521 filed Aug. 17, 2011 entitled “SELECTIVE MAP MARKER AGGREGATION,” the disclosure of which is wholly incorporated by reference in its entirety herein.

Some moments may not necessarily have location values associated therewith, or are in such close proximity to each other that rendering each one as markers 136 individually may be impractical. In those circumstances, the moments section 130 may serve as a visual inventory of the remaining moments that are associated with the displayed location on the map.

The particulars shown herein are by way of example and for purposes of illustrative discussion of the embodiments of the present disclosure only and are presented in the cause of providing what is believed to be the most useful and readily understood description of the principles and conceptual aspects. In this regard, no attempt is made to show details of the present invention with more particularity than is necessary, the description taken with the drawings making apparent to those skilled in the art how the several forms of the present invention may be embodied in practice.

What is claimed is:

1. A method for aggregation of content elements generated on one or more social networking service sites by a first user, the method comprising:
transmitting, from an aggregation platform system, a first content request to preselected ones of the one or more social networking service sites, the content request being associated with the first user and identifying an independently established account of the first user and content elements linked thereto on the preselected ones of the one or more social networking service sites;
receiving selected ones of the content elements generated by the social networking service sites in response to the first content request;
storing the received content elements as social objects in connection with a first aggregation account for the first user on the aggregation platform system, the social objects each being defined by a plurality of attributes; and
generating on the aggregation platform system a set of data representative of the selection of at least one of the social objects including one or more of the attributes thereof for rendering on a remote computer system, the selection of the social objects being defined by one or more predetermined conditions.

2. The method of claim 1, further comprising:
transmitting the set of data to a first client system of the first user.

3. The method of claim 1, further comprising:
transmitting at least a subset of the data representative of the selection of at least one of the social objects including one or more of the attributes thereof to a second client system of a second user;
wherein the second user is associated with a second aggregation account on the aggregation platform system.

4. The method of claim 3, wherein the one or more predetermined conditions includes an association link established between the first aggregation account and the second aggregation account.

5. The method of claim 3, wherein the one or more predetermined conditions includes a location comparison between the first user and the second user being within a proximity threshold, at least one of the social objects linked with the first aggregation account and at least one of the social objects linked with the second aggregation account having a location attribute.

6. The method of claim 5, wherein the proximity threshold is set by a bounding area defined on a user-navigable map rendered on the second client system.

7. The method of claim 3, further comprising:
transmitting, from the aggregation platform system, a second content request to another preselected ones of the one or more social networking service sites, the second content request being associated with the second user and identifying an independently established account of the second user and content elements linked thereto on the another preselected ones of the one or more social networking service sites;
receiving selected ones of the content elements generated by the social networking service sites in response to the second content request; and
storing the received content elements as social objects in the second aggregation account for the second user on the aggregation platform system.

8. The method of claim 7, wherein a rendering arrangement of the set of data representative of the selected social objects is defined by a modification timestamp associated with each of the social objects of the first aggregation account and the second aggregation account.

9. The method of claim 8, wherein one of the attributes of the social object is a text comment, the modification timestamp being updated in response to storing the text comment in the social object.

10. The method of claim 8, wherein one of the attributes of the social object is a persistence indicator, the modification timestamp being updated in response to setting the persistence indicator in the social object.

11. The method of claim 8, wherein one of the attributes of the social object is a favorability indicator, the modification timestamp being updated in response to setting the favorability indicator in the social object.

12. The method of claim 1, wherein a rendering arrangement of the set of data representative of the selected social objects is defined by a modification timestamp associated with each of the social objects of the first aggregation account.

13. A method for aggregating social objects with a unified platform, comprising:
presenting login credentials for a first aggregation account from a client system to the unified platform;
transmitting, upon a login approval, social object requests to the unified platform for selective retrieval of the social objects specified thereby, content elements received from one or more social networking service sites being stored with associated attributes as the social objects on the unified platform;
receiving on the client system a set of data representative of selected ones of the social objects, a first one of the attributes associated with the social objects being at least partially determinative of which of the social objects are selected;
rendering the set of data representative of the selected ones of the social objects on the client system in an arrangement at least partially determined by a second one of the attributes associated with the social objects.

14. The method of claim 13, wherein the first one of the attributes is an owner identifier.

15. The method of claim 14, wherein the owner identifier corresponds to the first user, at least one of the social objects being associated with the first aggregation account, and the corresponding content element of the one of the social object originating from an independent account of the first user on one of the social networking service sites.

16. The method of claim 14, wherein the owner identifier corresponds to a second user having a second aggregation account on the unified platform, at least one of the social objects being associated with the second aggregation account and the corresponding content element of the social object originating from another independent account of a second user on one of the social network service sites.

17. The method of claim 16, wherein an association link is established between the first aggregation account and the second aggregation account.

18. The method of claim 16, wherein another one of the attributes is a location identifier.

19. The method of claim 18, further comprising:
rendering a map on the client system, a graphic representative of the first user and the second user being overlaid thereon based upon the location identifier of the respective social objects.

20. The method of claim 13 wherein:
the second one of the attributes is a modification timestamp representative of a last instance in time in which one of the attributes of the social object was changed; and
a rendering arrangement of the set of data representative of the selected ones of the social objects is defined by the modification timestamp.

21. The method of claim 20, wherein:
a third one of the attributes of the social object is a text comment;
the modification timestamp is updated in response to storing the text comment in the social object; and
the text object is rendered on the client system.

22. The method of claim 20, wherein:
a third one of the attributes of the social object is a persistence indicator; and
the modification timestamp is updated in response to setting the persistence indicator in the social object.

23. The method of claim 20, wherein:
a third one of the attributes of the social object is a favorability indicator;
the modification timestamp is updated in response to setting the favorability indicator in the social object; and
a graphic representative of the set favorability indicator is rendered on the client system.

24. An article of manufacture comprising a non-transitory program storage medium readable by a data processing apparatus, the medium embodying one or more programs of instructions executable by the data processing apparatus to perform a method for aggregating social objects on a unified platform, the method comprising:
presenting login credentials for a first aggregation account from the data processing apparatus to the unified platform;
transmitting social object requests to the unified platform for selective retrieval of the corresponding social objects, content elements received from one or more social networking service sites being stored with associated attributes as the social objects on the unified platform;
receiving on the data processing apparatus a set of data representative of selected ones of the social objects, a first one of the attributes associated with the social objects being at least partially determinative of which of the social objects are selected; and
rendering the set of data representative of the selected ones of the social objects on the data processing apparatus in an arrangement at least partially determined by a second one of the attributes associated with the social objects.

25. The article of manufacture of claim 24, wherein the data processing apparatus is a mobile computing device.
